(19) United States
(12) Patent Application Publication
(10) Pub. No.: US 2024/0154201 A1
(43) Pub. Date: May 9, 2024

(54) BATTERY TEMPERATURE CONTROL SYSTEM

(71) Applicant: Cirrus Logic International Semiconductor Ltd., Edinburgh (GB)

(72) Inventor: John L. MELANSON, Austin, TX (US)

(73) Assignee: Cirrus Logic International Semiconductor Ltd., Edinburgh (GB)

(21) Appl. No.: 18/470,837

(22) Filed: Sep. 20, 2023

Related U.S. Application Data
(60) Provisional application No. 63/423,157, filed on Nov. 7, 2022.

(30) Foreign Application Priority Data
Jan. 6, 2023 (GB) 2300189.4

(51) Int. Cl. H01M 10/633; H01M 10/48; H01M 10/617; H01M 10/637

(52) U.S. Cl. CPC H01M 10/633; H01M 10/486; H01M 10/617; H01M 10/637; H01M 2200/106; H01M 2200/108; H01M 2220/30

(57) ABSTRACT

A battery temperature control system for controlling a temperature of a battery of an electronic device, the battery temperature control system comprising: a heating component network comprising a heat-dissipating component; and a heating controller, wherein the heating controller is configured to: receive an indication of a temperature of the battery; and output a control signal to control operation of a heat dissipating component of the heating component network so as to dissipate heat to at least a portion of the battery.

### FIELD OF THE INVENTION

The present disclosure relates to the field of battery charging, and in particular to optimising or at least improving thermal conditions and/or parameters of a battery to improve one or more charging conditions and/or parameters such as temperature, speed, efficiency or the like.

### BACKGROUND

Rechargeable batteries or cells are used to power a wide range of electronic devices such as, for example, mobile telephones, tablet and laptop computers, portable media players, portable gaming devices and the like. The charging performance of such batteries or cells, in terms of charging speed, efficiency, charging capacity, battery life following charging or other parameters, may vary according to at least the temperature of the battery or cell and/or the temperature gradient across the battery or cell. For some battery or cell chemistries the charging performance may be improved or optimised if the battery or cell is maintained at a predetermined temperature or within a predetermined temperature range during charging.

In a typical battery powered electronic device, the battery may be a relatively flat component, in the sense that its thickness is less than its length and/or width. When installed in the electronic device, the battery or cell may be positioned in close proximity to other components or subsystems such as, for example, a central processing unit (CPU), an applications processor, an audio amplifier, a power supply subsystem, an RF subsystem, a memory subsystem, a graphics processing unit or the like.

FIG. 1 is a schematic view from above, showing one possible physical layout of components and subsystems in battery powered electronic device 100. As shown in FIG. 1, the device 100 includes a single battery (or cell) 110 and a plurality of components or subsystems, in this example including an RF subsystem 122, an applications processor (AP) 124, an audio amplifier 126, a memory subsystem 128, a central processing unit (CPU) 130 and other components or subsystems 140-1-140-n disposed in proximity to the battery 110, at different positions relative to the battery 110. It will be appreciated by those of ordinary skill in the art that, depending on the design of the electronic device, the components or subsystems may be sited above and/or below the larger surface(s) of the battery or cell, instead of (or in addition to) being sited adjacent to side walls of the battery as illustrated in FIG. 1.

When active, the components and/or subsystems 122-140-n act as heat sources, in the sense that they generate and dissipate heat. The heat may be transferred (e.g. through thermal conduction) to the battery 110. As will be appreciated, different regions of the battery 110 will be heated depending upon which of the components and/or subsystems 122-140-n of the electronic device 100 are active at a given time, leading to a non-uniform temperature distribution within and/or across the battery 110. For example, a temperature gradient may exist between different portions, locations or regions of the battery 110, such as a first (e.g. upper) surface and an opposed (e.g. lower) second surface.

Other factors will also affect the heat distribution in the battery 110.

For example, heating of the battery 110 as a result of charging of the battery 110 may be non-uniform (e.g. different regions of the battery 110 may be at different temperatures) in batteries of certain constructions, chemistries or the like.

Additionally, the thermal environment in the vicinity of the device 100 will affect the distribution of heat in the device 100 and its battery 110. For example, if the device 100 is placed face up on a marble countertop, a lower surface of the battery 110 may be at a different (e.g., lower) temperature than an upper surface of the battery 110, whereas if the device 100 is placed face up on a car dashboard, the upper surface of the battery 110 may be at a higher temperature than the lower surface. Similarly, if the device 100 is in a user's hand or pocket, a portion of the battery 110 that is closest to the user's hand or body may be at a higher temperature than other portions that are further from the user's hand or body.

As will be appreciated by those of ordinary skill in the art, the wide variety of factors that affect the distribution of heat in the battery 110 of a device 100 makes it difficult to maintain the whole of the battery 110 at a particular temperature or within a particular temperature range at which charging performance is improved or optimised.

### SUMMARY

According to a first aspect, the invention provides a battery temperature control system for controlling a temperature of a battery of an electronic device, the battery temperature control system comprising:
a heating component network comprising a heat-dissipating component; and
a heating controller,
wherein the heating controller is configured to:
   receive an indication of a temperature of the battery; and
   output a control signal to control operation of a heat dissipating component of the heating component network so as to dissipate heat to at least a portion of the battery.

The battery temperature control system may further comprise:
a temperature sensor network comprising a temperature sensor, the temperature sensor network being configured to supply the indication of the temperature of the battery to the heating controller.

The temperature sensor network may comprise a temperature sensor of a component or subsystem of the electronic device.

The component or subsystem may be one of a digital signal processor (DSP), central processing unit (CPU), applications processor (AP), audio amplifier or memory subsystem.

The temperature sensor network may comprise a dedicated temperature sensor of the battery temperature control system.

The heating component network may comprise a component or subsystem of the electronic device.

The component or subsystem may be one of a DSP, CPU, AP, audio amplifier or memory subsystem.

The control signal may cause the component or subsystem to dissipate heat by performing unnecessary work or by operating in a low efficiency mode or by operating at a higher voltage than is necessary.

The heating component network may comprise a dedicated heating device of the battery temperature control system.

The temperature sensor network may comprise a dedicated temperature sensor of the battery temperature control system. The dedicated temperature sensor and the dedicated heating device may be integrated into a combined sensing and heating module.

The dedicated temperature sensor may comprise a device with a temperature dependent current-voltage characteristic. The dedicated heating device may comprise a resistive device.

The dedicated temperature sensor and the dedicated heating device may be the same component.

The component may be of a positive temperature coefficient (PTC) material such as PTC rubber.

The combined sensing and heating module may be a bidirectional combined sensing and heating module.

The bidirectional combined sensing and heating module may comprise:
a first series combination of a first device with a temperature dependent current-voltage characteristic and a first resistive device; and
a second series combination of a second device with a temperature dependent current-voltage characteristic and a second resistive device,
wherein the first and second series combinations are coupled in anti-parallel.

The heating component network and the temperature sensor network may be implemented as an array of selectable combined sensing and heating modules.

The heating controller may be configured to:
receive a plurality of sense signals from the temperature sensor network;
based on the received plurality of sense signals, generate a temperature profile of the battery; and
based on the temperature profile, output one or more control signals to the switch network for controlling the heating component network to dissipate heat to the battery or to one or more portions of the battery to at least partially equalise a temperature of the battery.

The heating controller may be configured to determine an amount of heat required to at least partially equalise a temperature of the battery based on a heat dissipation model and the received indication of the temperature of the battery.

The heating controller may be configured to perform a Kalman filtering operation to periodically update the heat dissipation model.

The at least one control signal may comprise a pulse width modulated (PWM) signal, for example.

The indication of the temperature of the battery may be based on a voltage and/or a current of the battery.

The heating controller may be configured to output one or more control signals to the switch network for controlling the heating component network to dissipate heat to the battery to a target battery temperature or to a temperature within a target range of battery temperatures.

The heating controller may be configured to adjust the target battery temperature or target range of battery temperatures based on one or more conditions or circumstances of the electronic device.

The heating controller may be configured to adjust the target battery temperature or target range of battery temperatures based on one or more of:
one or more device sensor outputs indicative of whether the device is in use;
one or more device sensor outputs indicative of whether the device is being held by a user; and
one or more device sensor outputs indicative of whether the device is at rest on a surface.

The heating controller may be implemented in integrated circuitry.

A switch network may be implemented in the integrated circuitry.

The heating controller may be configured to:
receive an indication of a temperature of the battery; and
output at least one control signal to the switch network to control operation of a heat dissipating components of the heating component network so as to dissipate heat to at least a portion of the battery.

According to a second aspect, the invention provides a battery temperature control system for controlling a temperature of a battery of an electronic device, the battery temperature control system comprising:
an array of combined sensing and heating modules; and
a heating controller,
wherein the heating controller is configured to:
   receive at least one sense signal indicative of a temperature of the battery from the array of combined sensing and heating modules; and
   based on the received at least one sense signal, output at least one control signal to the array of combined sensing and heating modules to cause heat dissipation to the battery to at least partially equalise a temperature of the battery and/or to raise a temperature of the battery to a target temperature or to a temperature within a target temperature range.

According to a third aspect, the invention provides a combined sensing and heating module comprising a first device having a temperature dependent current-voltage characteristic and a second device configured to convert electrical power into heat.

The first device may be coupled in series with the second device.

The first device may be a first diode or diode-connected transistor and the second device may be a first resistor.

The combined sensing and heating module may further comprise a second diode or diode-connected transistor connected in series with a second resistor, the combination of the second diode or diode-connected transistor and the second resistor being coupled in anti-parallel with the combination of the first diode or diode-connected transistor and the first resistor

The first device and the second device may be the same device.

The first device and/or the second device are of a PTC material.

The first device and/or the second device are of PTC rubber.

According to a fourth aspect, the invention provides a battery comprising one or more of:
a heating component;
a sensing component;
a combined sensing and heating module;
a component of a PTC material;
a component of PTC rubber; and
a heating controller.

According to a fifth aspect, the invention provides battery temperature control system comprising: one or more of a self-regulating heater, a PTC heater, a heat transfer sensor, a heating module and a sensing and/or heating module configured to equalise a temperature of a battery to a target temperature or to a temperature within a target temperature range.

The battery temperature control system may further comprising a heating controller configured to control the operation of the one or more of a self-regulating heater, a PTC heater, a heat transfer sensor, a heating module, and/or a sensing and heating module.

The heating controller may be configured to turn the one or more of a self-regulating heater, a PTC heater, a heat transfer sensor, a heating module, and/or a sensing and heating module on or off.

The one or more of a self-regulating heater, a PTC heater, a heat transfer sensor, a heating module, and/or a sensing and heating module may comprise a PTC material.

The PTC material may be PTC rubber.

The PTC material may be a laminate material comprising copper.

The laminate material may further comprise an insulating material.

The one or more of a self-regulating heater, a PTC heater, a heat transfer sensor, a heating module, and/or a sensing and heating module may comprise a diode.

The diode may comprise a diode-connected transistor.

The one or more of a self-regulating heater, a PTC heater, a heat transfer sensor, a heating module, and/or a sensing and heating module may comprise a heating device.

The heating device may comprise a resistive element.

According to a sixth aspect, the invention provides a host device comprising a battery temperature control system according to the first or third or fifth aspect, and/or a heating controller according to the second aspect and/or a battery according to the fourth aspect.

The host device may comprise a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.

### BRIEF DESCRIPTION OF THE DRAWINGS

Embodiments of the invention will now be described, strictly by way of example only, with reference to the accompanying drawings, of which:

FIG. 1 schematic view from above, showing one possible physical layout of components and subsystems in battery powered electronic device;

FIG. 2 is a schematic functional block diagram illustrating a battery temperature control system for a battery of an electronic device according to the present disclosure;

FIGS. 3a-3h are schematic diagrams showing the physical positioning of heating modules in relation to a battery in a battery powered electronic device;

FIG. 4 is a schematic representation of a combined sensing and heating module for use with the battery temperature control system of FIG. 2;

FIG. 5 is a schematic representation of sensing and heating circuit that incorporates the combined sensing and heating module of FIG. 4;

FIG. 6 is a schematic representation of an n×m matrix of combined sensing and heating modules for use in a battery temperature control system;

FIG. 7 is a schematic representation of a bidirectional combined sensing and heating module for use with the battery temperature control system 2;

FIG. 8 is a schematic representation of an n×m matrix of bidirectional combined sensing and heating modules for use in a battery temperature control system; and

FIG. 9 is a schematic representation of a battery temperature control system comprising a heating controller and a network of combined sensing and heating modules.

### DETAILED DESCRIPTION

To optimise or at least improve the thermal conditions of a battery or cell (hereinafter referred to as a battery, for simplicity) of a portable battery powered device when charging the battery, a battery temperature control system according to the present disclosure receives a signal indicative of a temperature at at least one region, portion or location of the battery, and controls at least one heat generating device or component to supply heat to the at least one region, portion or location of the battery based at least in part on the received signal, to equalise, at least partially, the temperature of the battery so as to achieve a more uniform battery temperature, and/or to raise the temperature of the battery to a predetermined temperature or to a temperature within a predetermined temperature range.

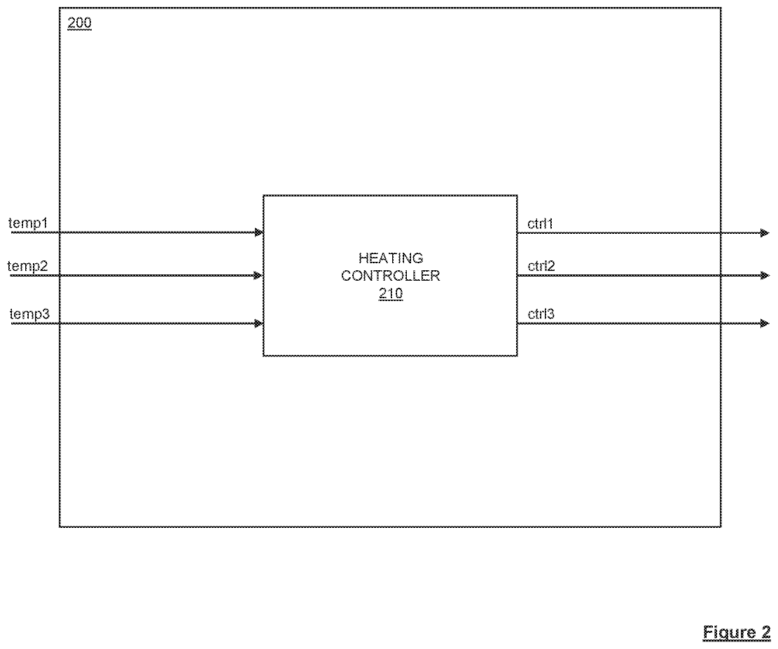

FIG. 2 is a schematic functional block diagram illustrating a battery temperature control system for a battery of an electronic device according to the present disclosure.

The battery temperature control system, shown generally at 200 in FIG. 2, includes a heating controller 210 which is operative to monitor and adjust and/or equalise a temperature of the battery prior to and/or during charging of the battery.

The heating controller 210 is configured to receive one or more signals, each indicative of a temperature of the battery or the temperature of a portion or portions of the battery, and to output one or more control signals to control one or more heat generating or dissipating components within the electronic device, based on the received signals, so as to apply heat to the battery or to one or more portions of the battery in order to adjust and/or equalise the temperature of and/or across the battery.

The heating controller 210 may be a dedicated heating controller implemented, for example, in discrete circuitry, integrated circuitry or in processing circuitry (e.g. an ASIC, FPGA or the like) executing appropriate instructions. Alternatively, the heating controller may be implemented using suitable instructions executed by a digital signal processor (DSP) of the electronic device, e.g. a central processing unit (CPU), applications processor (AP) or the like.

In the illustrated example the heating controller 210 receives three input signals (labelled temp1, temp2, temp3) indicative of the temperature of the battery or a respective portion of the battery, but those skilled in the art will appreciate that the heating controller 210 could receive more or fewer such input signals.

Similarly, in the illustrated example the heating controller 210 outputs three control signals (labelled ctrl1, ctrl2, ctrl3) to control heat generating components within the electronic device, but those skilled in the art will appreciate that the heating controller could output more or fewer such control signals and that the number of control signal may not necessarily correspond to the number of input signals.

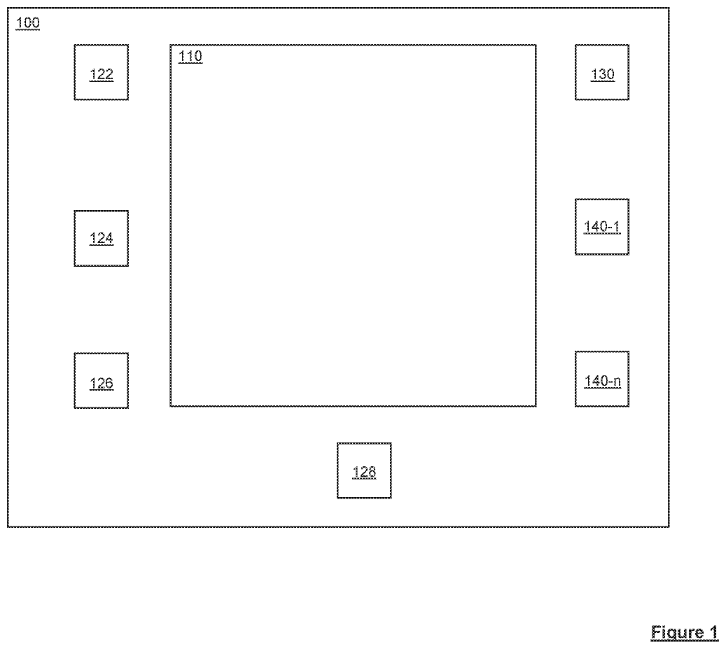

The input signal(s) indicative of the temperature of the battery (or portions thereof) may be provided by temperature sensors belonging to components or subsystems of the device that are located in proximity to the battery. For example, referring to FIG. 1, the signals indicative of the temperature of the battery may be provided by temperature sensors belonging to one or more of the RF subsystem 122, the AP 124, the audio amplifier 126, the memory subsystem 128, the CPU 130 and/or one or more of the other components or subsystems 140-1-140-n.

By using signals from temperature sensors belonging to existing components or subsystems 122-140-n of the electronic device, the heating controller 210 may be able to generate a temperature “map” or profile of the battery and its surrounding region, identifying the temperature of different portions or regions of the battery and/or differences in temperature between different portions, locations or regions of the battery. This temperature map may be used by the heating controller 210 to generate control signals for controlling heat-dissipating components within the device to cause heating of the battery (or portions thereof) as necessary so as to equalise the temperature of the battery and/or to heat the temperature of the battery to a target temperature or to a temperature within a target temperature range.

For example, if the temperature map indicates that a particular portion of the battery, or a region in the vicinity of the particular portion of the battery, is at a lower temperature than the rest of the battery, the heating controller 210 may generate and output one or more control signals to cause one or more heat-dissipating components in proximity to the indicated location, portion or region to dissipate more heat, thereby heating the particular location, portion or region of the battery and equalising (at least partially) the temperature of the battery.

Alternatively, the input signal(s) indicative of the temperature of the battery (or portions thereof) may be provided by one or more dedicated battery temperature sensors that are disposed about the battery, e.g., physically attached to or integrated with the battery, or disposed within a battery housing region of the electronic device such that, when the battery is installed in the device, the dedicated battery temperature sensor(s) are positioned in proximity to the battery.

In some examples the dedicated battery temperature sensor(s) may each form part of a combined sensing and heating module, a self-regulating heater, a PTC heater, or a heat transfer sensor as described in more detail below. Such modules, heaters and sensors may be disposed about the battery and/or within a battery housing region in proximity to the battery.

The use of such dedicated battery temperature modules, heaters and/or sensors enables the heating controller 210 to generate a temperature map of the battery, which can then be used by the heating controller 210 to identify cooler portions or regions of the battery and to generate control signals for appropriate heat-dissipating components to dissipate heat to the identified cooler portions or regions of the battery so as to equalise (at least partially) the temperature of the battery and/or to heat the temperature of the battery to a target temperature or to a temperature within a target temperature range.

Additionally or alternatively, a combination of signals from one or more dedicated battery temperature modules, heaters and/or sensors and signals from one or more temperature sensors belonging to existing components or subsystems 122-140-n of the electronic device can be used by the heating controller 210 to generate a temperature map of the battery which can be used as described above to identify cooler portions or regions of the battery and generate appropriate control signals for relevant heat-dissipating components to heat the identified portions or regions so as to equalise (at least partially) the temperature of the battery and/or to heat the temperature of the battery to a target temperature or to a temperature within a target temperature range.

The control signal(s) output by the heating controller 210 may be output to components or subsystems of the device that are located on, at or in proximity to the battery to cause such components or subsystems to generate and dissipate heat in order to heat up the battery. For example, referring again to FIG. 1, the control signal(s) may be output to one or more of the RF subsystem 122, the AP 124, the audio amplifier 126, the memory subsystem 128, the CPU 130 and/or the other components or subsystems 140-1-140-n.

The control signal(s) may cause one or more of the components and subsystems 122-140-n to carry out otherwise unnecessary work, as far as the device is concerned, in order to generate heat that can be dissipated in the vicinity of the battery to raise its temperature.

For example, a control signal could be output by the heating controller 210 to the CPU to cause the main processor to perform a calculation, e.g. calculating the next digit of Pi to generate additional heat. Such a calculation could be unnecessary as far as the device is concerned. In some examples the CPU may be made available for use in distributed processing scheme (e.g. bitcoin mining or the like) in which it performs calculations for another remote computer/processor, to generate additional heat.

As another example, a control signal could be output by the heating controller 210 to the audio amplifier 126 to cause the audio amplifier to operate in a low efficiency mode in which it dissipates more heat than in operation in a more efficient mode, thereby causing the audio amplifier 126 to heat a nearby portion of the battery.

As a further example, a control signal could be output by the heating controller 210 to cause any digital element (e.g. a digital element included one or more of the other components or subsystems 140-1-140-n) to operate at a higher voltage than is necessary for computation, to increase the amount of heat dissipated by the digital element and thereby heat a nearby portion of the battery.

Alternatively, the control signal(s) output by the heating controller 210 may be output to one or dedicated heat-dissipating elements or components that are disposed about the battery and/or within the battery housing region of the electronic device such that, when the battery is installed in the device, the dedicated heat-dissipating components are positioned in proximity to the battery. In some examples the dedicated heat-dissipating elements or components may each form part of a combined sensing and heating module of the kind described in more detail below.

As well as outputting control signals to one or more heat-dissipating elements or components to heat particular portions of the battery so as to equalise (at least partially) the temperature of the battery, the heating controller 210 may also output control signals to one or more heat-dissipating components to raise the temperature of the battery as a whole to a predefined target temperature or a predefined target temperature range at which charging performance is optimised or at least improved (or to maintain the temperature of the battery at the predefined target temperature or within the predefined target temperature range).

In an alternative approach, the heating controller 210 may be provided with or may develop a model of the heat dissipation from the components and subsystems of the electronic device, and may use this model in conjunction with signals received from dedicated battery temperature sensors or temperature sensors belonging to other components or subsystems 122-140-n of the electronic device to generate suitable control signals for dedicated heat dissipating components and/or components or subsystems of the electronic device to cause those components and/or subsystems to dissipate heat to the battery or one or more portions of the battery.

For example, if the signals received from the temperature sensors indicate that a particular portion of the battery is at a lower temperature than the rest of the battery, the heating controller 210 may examine or interrogate the model to estimate or predict the amount of heat required to bring the particular portion of the battery up to the temperature of the rest of the battery to equalise the battery temperature. The heating controller 210 may then identify, among the heat dissipating components that are present in the electronic device (either dedicated heat dissipating components or existing components and/or subsystems of the electronic device), the heat dissipating component(s) that is (are) most likely to be able to supply the heat required to bring the particular portion of the battery up to the same temperature as the rest of the battery, and may then generate and output suitable control signals to the identified components to cause them to apply heat to the battery or the portion of the battery as necessary to equalise the temperature of the battery.

In some examples, the model may be updated or refined periodically with observations or measurements of the temperature of different portions of the battery and/or the electronic device, as reported by the various temperature sensors. This updating/refreshing process may be referred to as Kalman filtering, and helps to improve the accuracy of the predictions or estimates of the heat required to equalise the battery temperature.

The model may also take into account other conditions that may have a bearing on the amount of heat required to equalise the battery temperature. For example, if the electronic device is resting on a metal surface, heat will be conducted away from the device by the metal surface, and so more heating may be required to equalise the battery temperature and/or to attain a target battery temperature or battery temperature range than if the device was resting on a less thermally conductive surface such as a pillow.

Thus, the heating controller 210 may receive additional inputs from other non-temperature sensors of the electronic device, e.g., a camera, gyroscope or orientation sensor, an accelerometer, a positioning system receiver or the like. These inputs are indicative of conditions such as the position, orientation, location etc. of the device and may be used by the model to inform the predictions or estimates of the heat required to equalise the battery temperature and/or to attain a target battery temperature or battery temperature range.

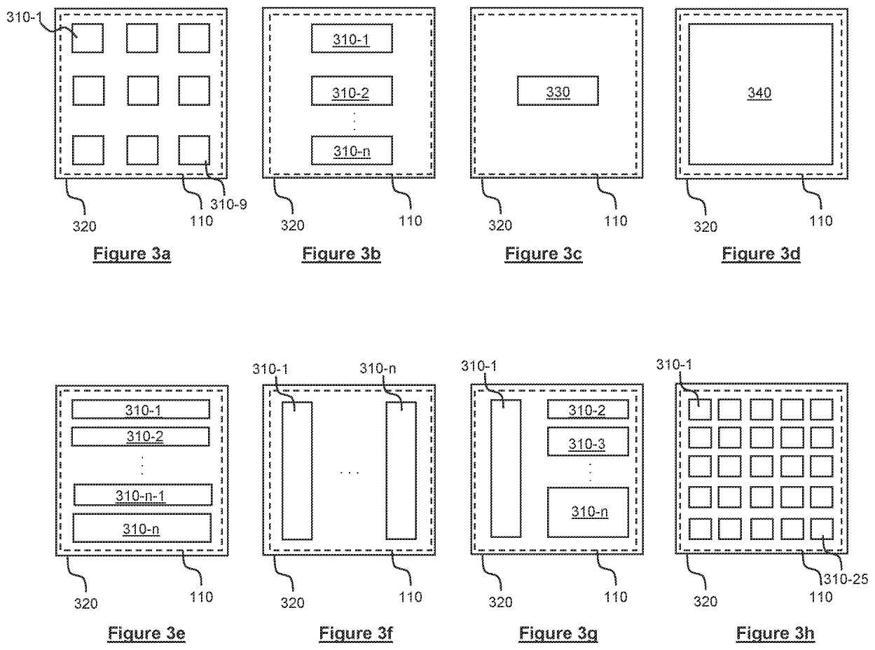

FIGS. 3a-3h are schematic diagrams showing examples of the physical positioning of heating modules, self-regulating heaters, PTC heaters and/or heat transfer sensors in relation to a battery in a battery powered electronic device.

In one example arrangement shown in FIG. 3a, a plurality (in this example 9) of heater modules 310-1-310-9 of substantially the same shape and size are arranged in a regular grid pattern, substantially equally spaced apart from one another, in a region of a battery housing 320 that is disposed adjacent a first (e.g. upper) or second (e.g. lower) side or surface of the battery 110 when the battery 110 is installed in the battery housing 320. Alternatively, the heater modules 310-1-310-9 may physically attached to or integrated with the first or second side or surface of the battery in the illustrated grid pattern arrangement. For reasons of brevity the term “heating module” as herein used may be substituted with any of the terms: “sensing and heating module”; “self-regulating heater”; “PTC heater”; and/or “heat transfer sensor”.

In an alternative example arrangement shown in FIG. 3b, a plurality (in this example n, where n is a positive integer) of substantially equally spaced-apart heater modules 310-1-310-n of substantially the same size are arranged in a vertical line extending along a central vertical axis of a portion of a battery housing 320 that is disposed adjacent a first (e.g. upper) or second (e.g. lower) side or surface of the battery 110 when the battery 110 is installed in the battery housing 320. Again, instead of being provided in the battery housing 320, the heater modules 310-1-310-n may be physically attached to or integrated with the first or second side or surface of the battery in the illustrated arrangement.

In a further alternative example arrangement shown in FIG. 3c, a single heater module is positioned in a generally central region of a portion of a battery housing 320 that is disposed adjacent a first (e.g. upper) or second (e.g. lower) side or surface of the battery 110 when the battery 110 is installed in the battery housing 320. In this example the heater module 330 is small relative to the size of the battery 110, such that a relatively small central portion of the first or second surface or side of the battery 110 is disposed adjacent the heater module 330 when the battery 110 is installed in the battery housing 320. Again, instead of being provided in the battery housing 320, the heater module 330 may be physically attached to or integrated with the first or second side or surface of the battery.

FIG. 3d shows a further alternative arrangement, in which a single heater module 340 is positioned in a generally central region of a portion of a battery housing 320 that is disposed adjacent a first (e.g. upper) or second (e.g. lower) side or surface of the battery when the battery 110 is installed in the battery housing 320. In this example the heater module 340 is almost the same size as the battery 110, such that a majority of the first or second surface or side of the battery 110 is disposed adjacent the heater module 310-1 when the battery 110 is installed in the battery housing 320. It will be appreciated by those skilled in the art that the single heater module 340 may be the same size as the first or second side or surface of the battery 110. Additionally, as in the previous examples, instead of being provided in the battery housing 320, the heater module 340 may be physically attached to or integrated with the first or second side or surface of the battery.

FIG. 3e shows a further alternative arrangement in which a plurality (in this example n, where n is a positive integer) of heater modules of substantially the same width but differing heights are arranged in a vertical line extending along a central vertical axis of a portion of a battery housing 320 that is disposed adjacent a first (e.g. upper) or second (e.g. lower) side or surface of the battery 110 when the battery 110 is installed in the battery housing 320. As in the previous examples, instead of being provided in the battery housing 320, the heater modules may be physically attached to or integrated with the first or second side or surface of the battery.

In a further alternative example arrangement shown in FIG. 3f, a plurality (in this example n, where n is a positive integer) of substantially equally spaced-apart heater modules 310-1-310-n of substantially the same size are arranged in a horizontal line extending along a horizontal vertical axis of a portion of a battery housing 320 that is disposed adjacent a first (e.g. upper) or second (e.g. lower) side or surface of the battery when the battery 110 is installed in the battery housing 320. As in the previous examples, instead of being provided in the battery housing 320, the heater modules 310-1-310-n may be physically attached to or integrated with the first or second side or surface of the battery.

FIG. 3g shows yet another example arrangement, in which a plurality (in the example n, where n is a positive integer) of heating modules of differing shapes and sizes are arranged over a region of a battery housing 320 that is disposed adjacent a first (e.g. upper) or second (e.g. lower) side or surface of the battery 110 when the battery 110 is installed in the battery housing 320. As in the previous examples, instead of being provided in the battery housing 320, the heater modules 310-1-310-n may be physically attached to or integrated with the first or second side or surface of the battery.

FIG. 3h shows a further example arrangement, in which a plurality (in this example 25) of heater modules 310-1-310-25 of substantially the same shape and size are arranged in a regular grid pattern substantially equally spaced apart from one another in a region of a battery housing 320 that is disposed adjacent a first (e.g. upper) or second (e.g. lower) side or surface of the battery 110 when the battery 110 is installed in the battery housing 320. It will be appreciated by those of ordinary skill in the art that FIG. 3h is a more granular version of the example illustrated in FIG. 3a and may therefore provide finer control of the temperature across the battery. Further, as in the previous examples, instead of being provided in the battery housing 320, the heater modules 310-1-310-25 may be physically attached to or integrated with the first or second side or surface of the battery.

As will be apparent from FIGS. 3a-3h, a wide variety of arrangements of heater modules are possible, and so it is to be understood that the arrangements shown in FIGS. 3a-3h are merely examples of possible arrangements. As will be appreciated by those of ordinary skill in the art, the specific arrangement of heating modules used in a particular application will be selected or designed based on a range of factors such as characteristics of the battery used, other components or subsystems that are positioned around the battery within the electronic device, thermal properties and characteristics of the electronic device and the like.

Moreover, although in the arrangements shown in FIGS. 3a-3h and described above the heating modules are positioned within a region of the battery housing 320 that is disposed adjacent either a first (e.g. upper) or a second (e.g. lower) side or surface of the battery 110 when the battery 110 is installed in the battery housing 320, it will be appreciated that in some examples one or more heating modules may be positioned in a first region of the battery housing 320 that is disposed adjacent the first side of the battery 110 when the battery 110 is installed in the battery housing 320, and one or more heating modules may be positioned in a second region of the battery housing 320 that is disposed adjacent the second side of the battery 110 when the battery 110 is installed in the battery housing 320.

The heater modules 310-1-310-n, 330, 340 may be dedicated heating modules (i.e. may be configured to perform only a heating function) configured to convert electrical power into heat, or may each form part of a combined sensing and heating module of the kind described in more detail below. The heater modules 310-1-310-n, 330, 340 may comprise resistive heating elements (e.g. printed resistors), for example, or may be formed from conductive traces or wiring of a substrate such as a printed circuit board on which the heating modules are mounted. Alternatively, the heater modules 310-1-310-n, 330, 340 may be implemented in integrated circuitry, e.g. as individual semiconductor die or portions of a semiconductor die implementing resistive heating elements, conductive traces or the like.

Each heater module 310-1-310-n, 330, 340 may be associated with a dedicated switch (which may form part of the heating controller 210) which controls a supply of electrical power to the heater module 310-1-310-n, 330, 340 (i.e. the switch turns the associated heater module on or off). Thus, when the switch associated with a particular heating module is open, no electrical power is supplied to that particular heating module and so that particular heating module does not convert any electrical power into heat. When the switch associated with a particular heater module is closed, electrical power is supplied to that heating module which thus converts the electrical power into heat. As an alternative to having a switch that is permanently closed, the switch may be opened and closed according to a duty cycle (e.g. by using a pulse width modulated (PWM) signal as the control signal for the switch), the amount of electrical power supplied to a heating module, and thus the amount of heat dissipated by that heating module, can be better controlled. A PWM or similar control signal is particularly suited to this application, as little power is provided to the heating controller 210. If the PWM rate or frequency is several Hertz or above, there will be no significant ripple in the temperature as a result of the control signal, because thermal time constants are typically of the order of seconds or more.

As will be appreciated, the heating modules may be regarded as constituting a network of heating modules, and the switches may be regarded as constituting a network of switches.

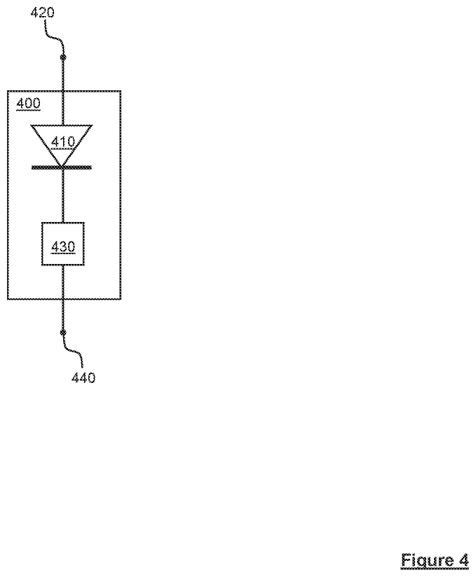

FIG. 4 is a schematic representation of a combined sensing and heating module which may be used to supply the signal(s) indicative of the temperature of the battery (or portions thereof) to the heating controller 210.

The combined sensing and heating module, shown generally at 400 in FIG. 4, comprises a series combination of a device 410 having a temperature dependent current-voltage characteristic and a heating device 430. Thus, in the example shown in FIG. 4 the combined sensing and heating module comprises a diode (or diode-connected transistor) 410 having an anode coupled to a first input node 420 of the combined sensing and heating module 400 and a cathode coupled to a first terminal of a heating device 430, which in this example is a resistor. A second terminal of the heating device is coupled to a second input node 440 of the combined sensing and heating module 400. This arrangement allows for sensitive temperature measurement and heating with simple voltage driving.

In an alternative example, the combined sensing and heating module 400 may comprise a resistor or other device with a known positive temperature coefficient, in particular a known high positive temperature coefficient, in place of the diode and heating device 430. The combined sensing and heating module may comprise a device made of a self-regulating heater material such as PTC (positive temperature coefficient) rubber, for example. A PTC material may be a laminate material comprising copper (or some other electrically conductive material). The laminate material may also include an insulating material. U.S. Pat. No. 8,367,986, which is incorporated in full by reference herein, describes an example of a PTC material which may be suitable for use in the combined sensing and heating module.

PTC material sheets can be used as thin flexible PTC heaters. Such PTC heaters produce the same amount of heat at each point of the heater which is conducted and radiated away from the PTC heater to the object to which it is attached, and its surroundings, so that the PTC heater is in constant thermal equilibrium with the environment, point by point. A measure of the power produced by the PTC heater is a measurement of the heat transfer between the PTC heater and the object to which it is attached. Hence, such a PTC heater can be used as a heat transfer sensor.

PTC material such as PTC rubber may advantageously be physically attached to and/or wrapped around one or more surfaces of the battery

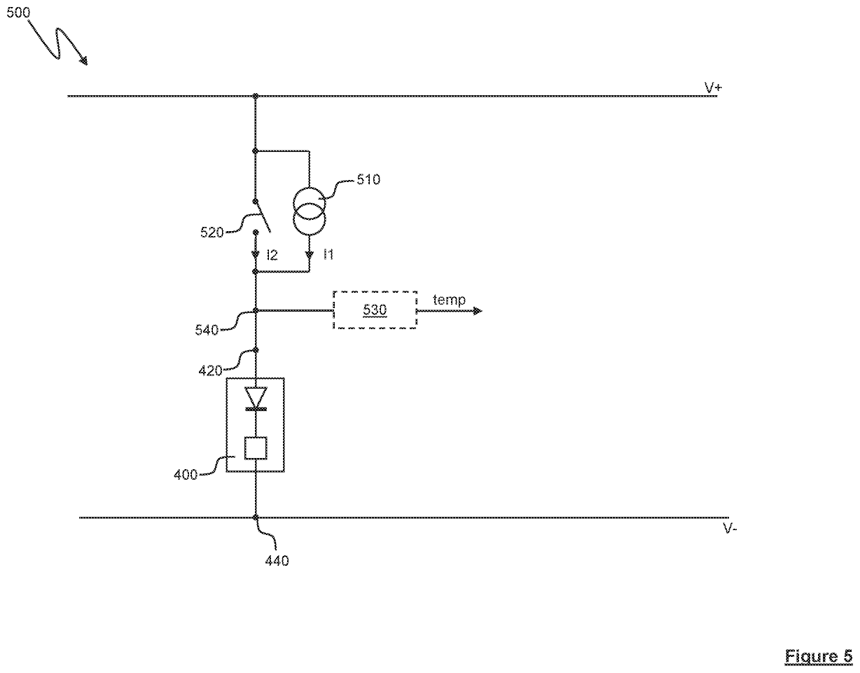

FIG. 5 is a schematic illustration of a circuit incorporating the combined sensing and heating module 400 for sensing the temperature of the battery (or a portion of the battery) and for heating the battery (or the portion of the battery).

As shown generally at 500, the circuit comprises a current source 510 coupled between a positive supply voltage rail V+ and the first input node 420 of the combined sensing and heating module 400. The second input node 440 of the combined sensing and heating module 400 is coupled to a negative supply voltage rail V−.

A switch 520 is coupled in parallel with the current source 510. The current source 510 and switch 520 may be provided as part of a heating controller 210 of the kind described above with reference to FIG. 2.

A voltage at a node 540 between the first input node 420 of the combined sensing and heating module 400 and the current source 510 is indicative of a temperature of the combined sensing and heating module 400. A voltage buffer 530 may be provided to buffer this voltage and to output a buffered signal (labelled temp) indicative of the temperature of the combined sensing and heating module 400, based on the voltage at the node 540. Alternatively the voltage buffer 530 may be omitted and the voltage at the node 540 may be directly used as the output signal temp indicative of the temperature of the combined sensing and heating module.

In use of the circuit 500, the switch 520 is open when the circuit 500 is operating in a temperature sensing mode, i.e., a first mode. When the circuit 500 is operating in a heating mode, i.e., a second mode, the switch 520 may be maintained in a closed state for the duration of the heating mode operation, or may alternatively be opened and closed in accordance with a duty cycle (e.g. by using a pulse width modulated (PWM) signal as the control signal for the switch 520). Thus, a heating controller 210 incorporating the switch 520 is able to control when the combined sensing and heating module 400 is used to sense temperature and when the combined sensing and heating module 400 is used to dissipate heat. Again, a PWM or similar control signal is particularly suited to this application, as little power is provided to the heating controller 210. If the PWM rate or frequency is several Hertz or above, there will be no significant ripple in the temperature as a result of the control signal, because thermal time constants are typically of the order of seconds or more.

In the first mode, i.e., the temperature sensing mode with the switch 520 open, a relatively low current I1 generated by the current source 510 flows through the combined sensing and heating module 400. The current I1 may be variable so as to permit adjustment of the voltage at the node 540, e.g. to improve sensitivity to small temperature changes. Alternatively, the current I1 may be a constant current. As the current-voltage characteristic of the combined sensing and heating module 400 is temperature dependent, the voltage at the node 540 is indicative of the temperature of the combined sensing and heating module 400.

In the second mode, i.e., the heating mode, with the switch 520 closed, a current I2, which is greater than the current I1 generated by the current source 510, flows through the combined sensing and heating module 400. This causes the combined sensing and heating module 400 to heat up. By operating the switch 520 in accordance with a duty cycle (e.g. by using a pulse width modulated (PWM) signal as the control signal for the switch 520) the amount of power supplied to the combined sensing and heating module 400, and thus the amount of heat dissipated by the combined sensing and heating module 400, can be controlled, with a higher duty cycle providing more power and thus leading to greater heat dissipation.

As will be appreciated, a plurality of combined sensing and heating modules 400 and their associated current sources 510 and switches 520 may be provided in an electronic device, to provide signals indicative of the temperature of the battery (or portions thereof) to the heating controller 210 and to supply heat to the battery in response to control signals output by the heating controller 210. In some examples a separate current source is provided for each combined sensing and heating module 400, while in other examples a single current source 510 may be coupled in parallel with all the switches 520, such that the single current source 510 is shared between all the combined sensing and heating modules 400. As will be appreciated by those of ordinary skill in the art, where a single current source 510 is provided, the output current supplied by the single current source 510 may be adjustable according to the number of combined sensing and heating modules 400 that are active at any given time.

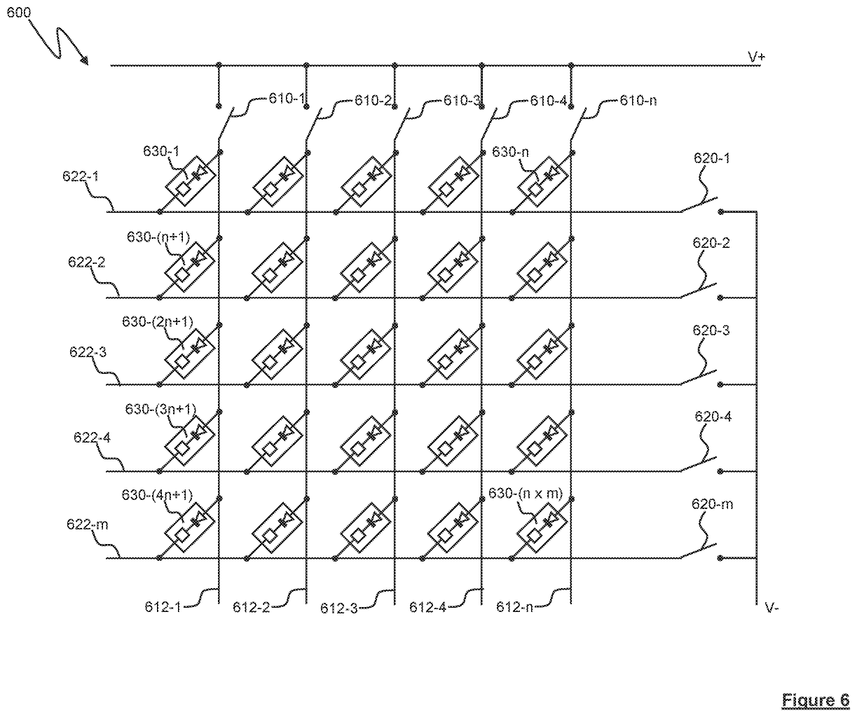

FIG. 6 is a schematic representation of an n×m array or matrix of selectable combined sensing and heating modules for use in a battery temperature control system.

The n×m array or matrix, shown generally at 600 in FIG. 6, comprises a switch network having a first plurality n (where n=5 in the illustrated example) of column switches 610-1-610-n and a second plurality m (where m=5 in the illustrated example) of row switches 620-1-620-m. Each of the column switches 610-1-610-n is configured to selectively couple a positive power supply rail to a respective one of a first plurality n of column electrodes 612-1-612-n, and each of the row switches 620-1-620-m is configured to selectively couple a negative power supply rail to a respective one of a second plurality m of row electrodes 622-1-622-m.

The switch network 610-1-610-n and 620-1-620-m may be provided as part of a heating controller (e.g., the heating controller 210 of FIG. 2), or may be external to the heating controller and controllable by the heating controller.

The matrix 600 further includes a set of (n×m) combined sensing and heating modules 630-1-630-(n×m). Thus, in the example illustrated in FIG. 6, the matrix 600 includes a set of (5×5=) 25 combined sensing and heating modules. The combined sensing and heating modules may be combined sensing and heating modules of the kind shown generally at 400 in FIG. 4, comprising a series combination of a device having a temperature dependent current-voltage characteristic and a heating device, or may be combined sensing and heating modules of the kind described above comprising a resistor or other device with a positive temperature coefficient, or may be any other suitable combined sensing and heating module.

Each combined sensing and heating module is coupled between a respective one of the plurality of column electrodes 612-1-612-n and a respective one of the plurality of row electrodes 622-1-622-m. For example, a first sensing and heating module 630-1 of the set is coupled between the first column electrode 612-1 and the first row electrode 622-1, while an (n×m)th sensing and heating module 630-(n×m) is coupled between the nth column electrode 612-n and the mth row electrode 622-m.

This switched matrix arrangement of the combined sensing and heating modules 630-1-630-(n×m) permits any single one of the combined sensing and heating modules 630-1-630-(n×m), or any combination of two or more of the combined sensing and heating modules 630-1-630-(n×m), to be selected for use in heating a battery without requiring a separate selector switch for each combined sensing and heating module 630-1-630-(n×m).

For example, to select the first combined sensing and heating module 630-1, the first column switch 610-1 and the first row switch 620-1 are closed, such that current can flow from the positive supply rail through the first combined sensing and heating module 630-1 to the negative supply rail. Similarly, to select the first and (n×m)th first combined sensing and heating modules 630-1, 630-(n×m), the first and nth column switches 610-1, 610-n and the first and mth row switches 620-1, 620-m are closed, thus allowing current to flow from the positive supply rail through the first and (n×m)th first combined sensing and heating modules 630-1, 630-(n×m).

The switched matrixed arrangement permits a reduction in the number of switches, and associated signal paths or signal routing channels, required from (n×m) switches (in an arrangement where there is a separate selector switch an associated wiring/signal routing) for each combined sensing and heating module 630-1-630-(n×m)) to (n+m) switches, and allows (n×m) heating locations to be controlled with only (n+m) drive signals.

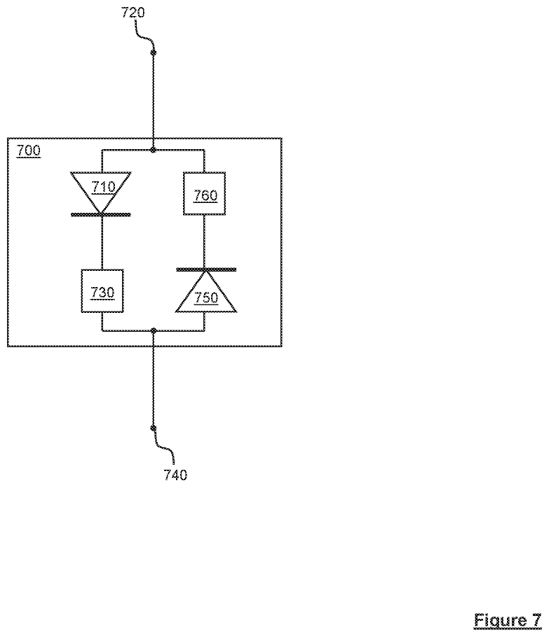

FIG. 7 is a schematic representation of a bidirectional combined sensing and heating module which may be used to supply the signal(s) indicative of the temperature of the battery (or portions thereof) to the heating controller 210.

The bidirectional combined sensing and heating module, shown generally at 700 in FIG. 7, comprises a first series combination of a first device having a temperature dependent current-voltage characteristic and a first heating device and a second series combination of a second device having a temperature dependent current-voltage characteristic and a second heating device, the second series combination being coupled in anti-parallel with the first series combination, i.e., the first and second series combinations are connected back-to-back with one another. Thus, in the example shown in FIG. 7 the bidirectional combined sensing and heating module comprises a first diode (or diode-connected transistor) 710 having an anode coupled to a first input node 720 of the bidirectional combined sensing and heating module 700 and a cathode coupled to a first terminal of a first heating device 730, which in this example is a first resistor. A second terminal of the first heating device is coupled to a second input node of the combined sensing and heating module 700. An anode of a second diode (or diode-connected transistor) 750 is coupled to the second input node 740, and a cathode of the second diode 750 is coupled to a first input of a second heating device 760, which in this example is a second resistor. A second terminal of the second heating device 760 is coupled to the first input node 720.

The bidirectional combined sensing and heating module 700 can be driven in either direction, i.e., by applying either a positive voltage or a negative voltage across the bidirectional combined sensing and heating module 700 between the second input node and the first input node 720. This reduces the amount of wiring and/or routing required to create an array or matrix of 2(n×m) individual combined sensing and heating modules.

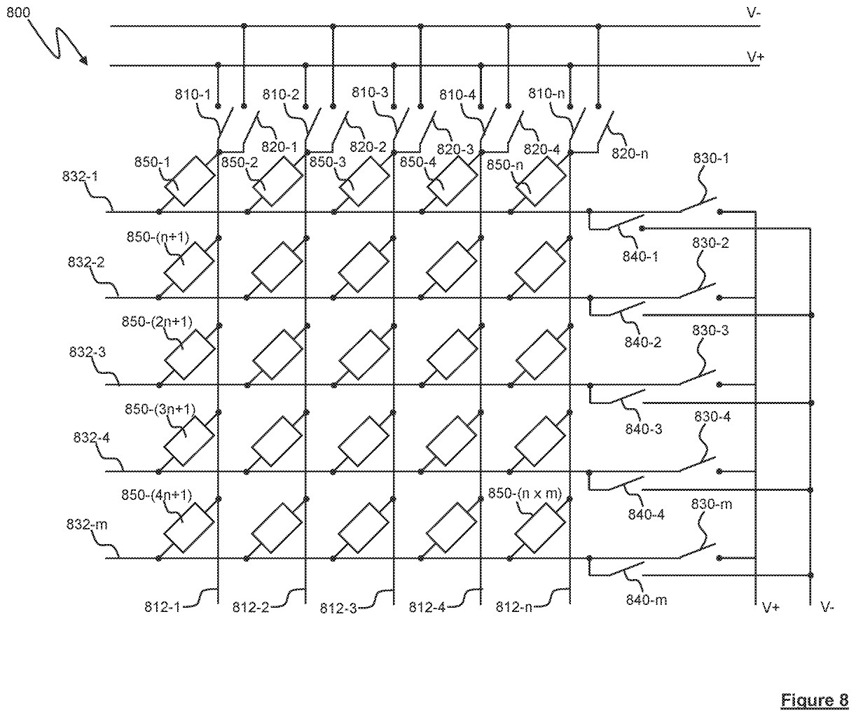

FIG. 8 is a schematic representation of an array or matrix of selectable combined sensing and heating modules for use in a battery temperature control system.

The matrix, shown generally at 800 in FIG. 8, comprises a switch network having a first plurality n (where n=5 in the illustrated example) of positive supply column switches 810-1-810-n, a first plurality n of negative supply column switches 820-1-820-n, a second plurality m (where m=5 in the illustrated example) of positive supply row switches 830-1-830-m and a second plurality m of negative supply row switches 840-1-840-m.

Each of the positive supply column switches 810-1-810-n is configured to selectively couple a positive power supply rail V+ to a respective one of a first plurality n of column electrodes 812-1-812-n, and each of the negative supply column switches 820-1-820-n is configured to selectively couple a negative power supply rail V− to a respective one of the first plurality n of column electrodes 812-1-812-n

Similarly, each of the positive row switches 830-1-830-m is configured to selectively couple a positive power supply rail V+ to a respective one of a second plurality m of row electrodes 822-1-822-m, and each of the negative row switches 830-1-830-m is configured to selectively couple a negative power supply rail V− to a respective one of the second plurality m of row electrodes 822-1-822-m.

The switch network may be provided as part of a heating controller (e.g. the heating controller 210 of FIG. 2), or may be external to the heating controller and controllable by the heating controller.

The matrix 800 further includes a set of (n×m) bidirectional combined sensing and heating modules 830-1-830-(n×m), such that the set of bidirectional combined sensing and heating modules includes a total of 2(n×m) individual combined sensing and heating modules. Thus, in the illustrated example the matrix 800 includes a set of (5×5=) 25 bidirectional combined sensing and heating modules, i.e., a total of 50 individual combined sensing and heating modules. The combined sensing and heating modules may be bidirectional combined sensing and heating modules of the kind shown generally at 700 in FIG. 7, or may be any other suitable bidirectional combined sensing and heating module.

Each bidirectional combined sensing and heating module is coupled between a respective one of the plurality of column electrodes 812-1-812-n and a respective one of the plurality of row electrodes 832-1-832-m. For example, a first combined sensing and heating module 850-1 of the set is coupled between the first column electrode 812-1 and the first row electrode 832-1, while an (n×m)th sensing and heating module 850-(n×m) is coupled between the nth column electrode 812-n and the mth row electrode 832-m.

This switched matrix arrangement of the bidirectional combined sensing and heating modules 850-1-850-(n×m) permits any single one of the bidirectional combined sensing and heating modules 850-1-850-(n×m), or any combination of two or more of the bidirectional combined sensing and heating modules 850-1-850-(n×m), to be selected for use in heating a battery without requiring a separate selector switch for each bidirectional combined sensing and heating module 850-1-850-(n×m). The direction of current flow through any selected bidirectional combined sensing and heating module 850-1-850-(n×m) can be selected by closing the appropriate row and column switches. For example, by closing the first positive column switch 810-1 and the first negative row switch 840-1, the first bidirectional combined sensing and heating module 850-1 can be selected, with current flowing from the positive power supply rail V+, through the first positive column switch 810-1, the first bidirectional combined sensing and heating module 850-1 and the first negative row switch 840-1 to the negative power supply rail V−.

Thus, the switched matrixed arrangement permits a reduction in wiring/routing and in the number of switches required from (n×m) switches (in an arrangement where there is a separate selector switch for each bidirectional combined sensing and heating module 850-1-850-(n×m)) to (n+m) switches.

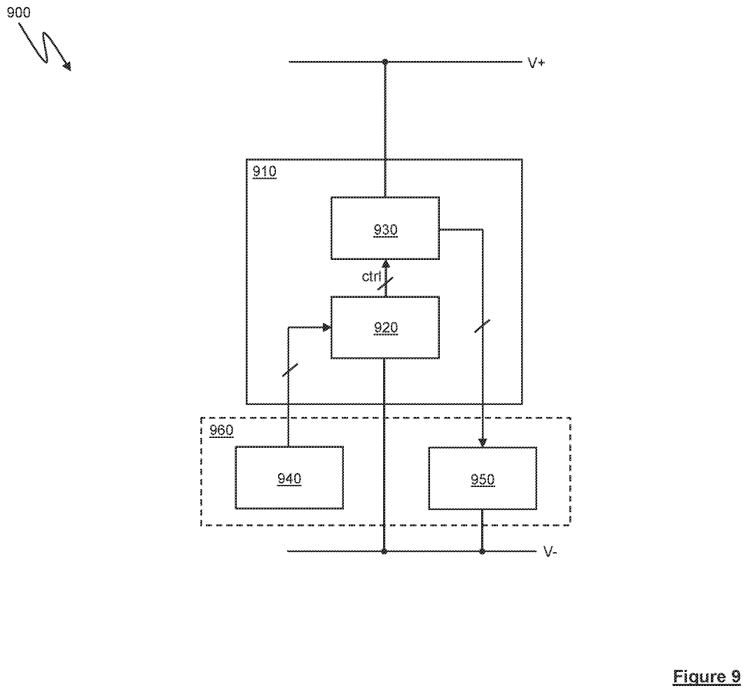

FIG. 9 is a schematic representation of a battery temperature control system for a battery powered electronic device.

The battery temperature control system, shown generally at 900 in FIG. 9, comprises control circuitry 910, temperature control circuitry 920 and a switch network 930, a sensor network 940 and a heating device network 950.

The control circuitry 910 may be implemented in integrated circuitry (e.g. as a single integrated circuit), or in discrete circuitry, or in suitably configured processing circuitry such as an FPGA, ASIC or the like executing appropriate instructions. In the example shown in FIG. 9 the temperature control circuitry 920 and the switch network 930 form part of the control circuitry 910, but it will be appreciated that the temperature control circuitry 920 and the switch network 930 may be separate from the control circuitry 910.

The sensor network 940 comprises one or more sensor devices or modules, each configured to output a sense signal indicative of a temperature in the vicinity of the sensor device or module. The sensor devices or modules of the sensor network 940 are positioned about the battery and/or in proximity to a battery of a battery powered device incorporating the battery temperature control system 900. The sensor device(s) or modules may be disposed about the battery and/or in or around a battery housing region of the battery powered electronic device, for example in one of the arrangements described above with reference to FIGS. 3a-3h, such that each sensor device or module outputs a sense signal indicative of a temperature of a region of the battery or of the battery as a whole.

The heating device network 950 comprises one or more heating devices or modules, each configured to convert electrical power into heat. The heating devices or modules of the heating device network 950 are positioned about the battery and/or in proximity to a battery of a battery powered device incorporating the battery temperature control system 900. The heating device(s) or modules may be disposed in or around a battery housing region of the battery powered electronic device, for example in one of the arrangements described above with reference to FIGS. 3a-3h, such that each heating device or module can dissipate heat to a respective region of the battery or to the battery as a whole.

The heating device network 950 is coupled to the switch network 930, such that each heating device can be selectively coupled to a source of electrical power (in the illustrated example a positive power supply rail V+) to cause the heating device to generate and dissipate heat.

In some examples the sensing device network 940 and the heating device network 950 may be implemented as a single network 960 (shown in dashed outline in FIG. 9) of combined sensing and heating modules of the kind described above with reference to FIG. 6 or a single network of bidirectional combined sensing and heating modules of the kind described above with reference to FIG. 8.

The battery temperature control system 900 may be operated prior to and/or during charging of the battery of the host electronic device to equalise, at least partially, a temperature of the battery and/or to raise the temperature of the battery to a predefined target temperature or a temperature within a predefined target temperature range, and to maintain the battery at the target temperature or within the target temperature range, in order to optimise or at least improve charging performance.

In operation of the battery temperature control system 900, the temperature control circuitry 920 receives sense signals from one or more of the sensing devices or modules, to determine or estimate an initial temperature of the battery or of different portions of the battery. The sensing devices or modules of the sensor network 940 may each be operative to continuously output a sense signal, in which case the temperature control circuitry 920 may poll one or more selected sensing devices or modules to receive the sense signals. In other examples the sensing devices or modules may be selectively operable, e.g. by means of suitable switch arrangement, in which case the temperature control circuitry 920 may output suitable control signals to select one or more of the sensing devices or modules to supply the sense signal(s).

In examples where the sensor devices or modules are provided by combined sensing and heating modules, it is preferable that for estimating the initial temperature, combined sensing and heating modules that are not operating in their heating mode and/or have not recently been operating in their heating mode are selected to provide the sense signals to the temperature control circuitry 920. Any combined sensing and heating modules that are or have recently been operating in their heating mode will be at a higher temperature than the nearby portion of the battery, and so the sense signals output by such modules will not provide as accurate an indication of the temperature of the battery (or a portion thereof) as sense signals output by combined sensing and heating modules that are not or have not recently been operating in their heating mode.

The temperature control circuitry 920 determines, based on the initial estimate of the temperature of the battery and/or the initial estimates of the different portions of the battery whether the battery is at a target temperature or within a target temperature range that optimises or improves charging performance, and/or whether there are any differences in temperature between different portions of the battery.

If the battery is not at the target temperature or within the target temperature range, and/or if there are differences in temperature between different portions of the battery, the temperature control circuitry 920 determines (e.g. based on a temperature map or profile or model, as described above with reference to FIG. 2) which of the heating devices or modules should be activated to heat the relevant portions of the battery, and estimates (e.g. based on a temperature map or profile or model, as described above with reference to FIG. 2) an amount of heat required to equalise the battery temperature and/or to attain a target temperature or temperature range, and outputs control signals to the relevant switches of the switch network 930 to supply electrical power to the relevant heating devices or modules of the heating device network 950.

In some examples operation of the selected heating devices or modules may be multiplexed in order to prevent excessive current draw from a power supply to the battery temperature control system 900.

As described above, the control signals may cause the relevant switches to close to provide a continuous supply of electrical power to the relevant heating devices or modules, or may cause the relevant switches to open and close according to a duty cycle (e.g. by using a pulse width modulated (PWM) signal as the control signal for the switch) to control the amount of electrical power supplied to the heating devices or modules and hence the amount of heat dissipated by the heating devices or modules to the battery. As in the previous examples, a PWM or similar control signal is particularly suited to this application, as little power is provided to the heating controller 210. If the PWM rate or frequency is several Hertz or above, there will be no significant ripple in the temperature as a result of the control signal, because thermal time constants are typically of the order of seconds or more.

During charging of the battery the temperature control circuitry 920 monitors, continuously or periodically (e.g. once per minute, once per 30 seconds etc.), the temperature of the battery and/or different portions of the battery by polling or switching the sensor devices or modules, and generates appropriate control signals for the switch network 930 to continue to equalise, at least partially, the temperature of the battery, and/or to maintain the temperature of the battery at the target temperature or within the target temperature range.

By actively controlling the temperature of the battery and/or individual portions of the battery in this way, an improved distribution of heat can be achieved in the battery, such that a uniform or near uniform temperature of the battery can be maintained, and the temperature of the battery can be maintained at a target temperature or within a target temperature range that optimises or at least improves charging performance.

The target temperature or target temperature range may vary according to the prevailing conditions or circumstances of the host device and/or the battery (based on battery parameters such as, for example, state of charge (SoC), storage capacity, energy density etc.). For example if the device is in use and being held (as may be detected or inferred, for example, from outputs of one or more sensors of the device, such as a gyroscope, accelerometer, rotation sensor or camera, for example, or any combination of such sensor outputs), a lower target temperature or target temperature range may be selected by the temperature control circuitry 920 than if the device is at rest on a table, worktop or the like (which may also be detected or inferred, for example, from outputs of one or more sensors of the device, such as a gyroscope, accelerometer, rotation sensor or camera, for example, or any combination of such sensor outputs).

In the examples described above, the sense signals indicative of the temperature of the battery or individual locations, portions or regions of the battery are described as being provided by temperature sensing devices or modules, either dedicated modules or devices for sensing the temperature of the battery (or regions thereof) or temperature sensing devices of other components or subsystems of the host electronic device.

However, in some examples it may suffice for the battery temperature to be estimated (e.g. by the temperature controller 210 or the temperature control circuitry 920) based on a measured voltage and current of the battery.

It will be appreciated by those of ordinary skill in the art that although the term “battery” has been used throughout this disclosure for reasons of clarity and simplicity, the techniques, methods, principles, systems and circuitry described herein are equally applicable to battery packs or other arrangements comprising a plurality of batteries, single cells and arrangements comprising a plurality of cells.

The circuitry described above with reference to the accompanying drawings may be incorporated in a host device such as, for example, a laptop, notebook, netbook or tablet computer, a gaming device such as a games console or a controller for a games console, a virtual reality (VR) or augmented reality (AR) device, a mobile telephone, a portable audio player, an electric scooter, bicycle, wheelchair, electric vehicle or some other portable/mobility device, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications, embodiments will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1.-49. (canceled)

50. A battery temperature control system for controlling a temperature of a battery of a portable electronic device prior to and/or during charging of the battery, the battery temperature control system comprising:
a heating component network comprising a heat-dissipating component; and
a heating controller,
wherein the heating controller is configured to:
receive an indication of a temperature of the battery; and
output a control signal to control operation of a heat dissipating component of the heating component network so as to dissipate heat to at least a portion of the battery.

51. A battery temperature control system according to claim 50, further comprising:
a temperature sensor network comprising a temperature sensor, the temperature sensor network being configured to supply the indication of the temperature of the battery to the heating controller.

52. A battery temperature control system according to claim 51, wherein the temperature sensor network comprises a temperature sensor of a component or subsystem of the electronic device.

53. A battery temperature control system according to claim 52, wherein the component or subsystem is one of a digital signal processor (DSP), central processing unit (CPU), applications processor (AP), audio amplifier or memory subsystem.

54. A battery temperature control system according to claim 52, wherein the temperature sensor network comprises a dedicated temperature sensor of the battery temperature control system.

55. A battery temperature control system according to claim 50, wherein the heating component network comprises a component or subsystem of the electronic device.

56. A battery temperature control system according to claim 55, wherein the component or subsystem is one of a digital signal processor (DSP), central processing unit (CPU), applications processor (AP), audio amplifier or memory subsystem.

57. A battery temperature control system according to claim 55, wherein the control signal causes the component or subsystem to dissipate heat by performing unnecessary work or by operating in a low efficiency mode or by operating at a higher voltage than is necessary.

58. A battery temperature control system according to claim 50, wherein the heating component network comprises a dedicated heating device of the battery temperature control system.

59. A battery temperature control system according to claim 58, wherein the temperature sensor network comprises a dedicated temperature sensor of the battery temperature control system, and wherein the dedicated temperature sensor and the dedicated heating device are integrated into a combined sensing and heating module.

60. A battery temperature control system according to claim 59, wherein the dedicated temperature sensor comprises a device with a temperature dependent current-voltage characteristic and the dedicated heating device comprises a resistive device.

61. A battery temperature control system according to claim 59, wherein the dedicated temperature sensor and the dedicated heating device are the same component.

62. A battery temperature control system according to claim 61, wherein the component is of a positive temperature coefficient (PTC) material such as PTC rubber.

63. A battery temperature control system according to claim 59, wherein the combined sensing and heating module is a bidirectional combined sensing and heating module comprising:
a first series combination of a first device with a temperature dependent current-voltage characteristic and a first resistive device; and
a second series combination of a second device with a temperature dependent current-voltage characteristic and a second resistive device,
wherein the first and second series combinations are coupled in anti-parallel.

64. A battery temperature control system according to claim 51, wherein the heating component network and the temperature sensor network are implemented as an array of selectable combined sensing and heating modules.

65. A battery temperature control system according to claim 51, wherein the heating controller is configured to:
receive a plurality of sense signals from the temperature sensor network;
based on the received plurality of sense signals, generate a temperature profile of the battery; and
based on the temperature profile, output one or more control signals to a switch network for controlling the heating component network to dissipate heat to the battery or to one or more portions of the battery to at least partially equalise a temperature of the battery.

66. A battery temperature control system according to claim 50, wherein the heating controller is configured to determine an amount of heat required to at least partially equalise a temperature of the battery based on a heat dissipation model and the received indication of the temperature of the battery.

67. A battery temperature control system according to claim 66, wherein the heating controller is configured to perform a Kalman filtering operation to periodically update the heat dissipation model.

68. A battery temperature control system according to claim 50, wherein the at least one control signal comprises a pulse width modulated (PWM) signal.

69. A battery temperature control system according to claim 50, wherein the indication of the temperature of the battery is based on a voltage and/or a current of the battery.

70. A battery temperature control system according to claim 50, wherein the heating controller is configured to output one or more control signals to a switch network for controlling the heating component network to dissipate heat to the battery to a target battery temperature or to a temperature within a target range of battery temperatures.

71. A battery temperature control system according to claim 70, wherein the heating controller is configured to adjust the target battery temperature or target range of battery temperatures based on one or more of:
one or more device sensor outputs indicative of whether the device is in use;
one or more device sensor outputs indicative of whether the device is being held by a user; and
one or more device sensor outputs indicative of whether the device is at rest on a surface.

72. A battery temperature control system according to claim 50, wherein the heating controller and/or a switch network is implemented in integrated circuitry.

73. A battery temperature control system according to claim 50, wherein the battery is a single cell battery.

74. A battery temperature control system for controlling a temperature of a battery of a portable electronic device prior to and/or during charging of the battery, the battery temperature control system comprising:
a heating controller; and
a combined heating and temperature sensing device,
wherein the heating controller is configured to:
receive an indication of a temperature of the battery; and
output a control signal to control operation of the combined heating and sensing device so as to dissipate heat to at least a portion of the battery.

75. A heating controller for a battery temperature control system according to claim 50, wherein the heating controller is configured to:
receive an indication of a temperature of the battery; and
output at least one control signal to a switch network to control operation of a heat dissipating components of the heating component network so as to dissipate heat to at least a portion of the battery.

76. A battery temperature control system for controlling a temperature of a battery of an electronic device, the battery temperature control system comprising:
an array of combined sensing and heating modules; and
a heating controller,
wherein the heating controller is configured to:
receive at least one sense signal indicative of a temperature of the battery from the array of combined sensing and heating modules; and
based on the received at least one sense signal, output at least one control signal to the array of combined sensing and heating modules to cause heat dissipation to the battery to at least partially equalise a temperature of the battery and/or to raise a temperature of the battery to a target temperature or to a temperature within a target temperature range.

77. A combined sensing and heating module comprising a first device having a temperature dependent current-voltage characteristic and a second device configured to convert electrical power into heat.

78. A combined sensing and heating module according to claim 77, wherein the first device is coupled in series with the second device.

79. A combined sensing and heating module according to claim 78, wherein the first device is a first diode or diode-connected transistor and the second device is a first resistor.

80. A combined sensing and heating module according to claim 79, further comprising a second diode or diode-connected transistor connected in series with a second resistor, the combination of the second diode or diode-connected transistor and the second resistor being coupled in anti-parallel with the combination of the first diode or diode-connected transistor and the first resistor.

81. A combined sensing and heating module according to claim 77, wherein the first device and the second device are the same device.

82. A combined sensing and heating module according to claim 81, wherein the first device and/or the second device are of a PTC material.

83. A combined sensing and heating device according to claim 82, wherein the first device and/or the second device are of PTC rubber.

84. A battery temperature control system comprising:
one or more of a self-regulating heater, a PTC heater, a heat transfer sensor, a heating module and a sensing and/or heating module configured to equalise a temperature of a battery to a target temperature or to a temperature within a target temperature range.

85. A battery temperature control system according to claim 84, further comprising a heating controller configured to control the operation of the one or more of a self-regulating heater, a PTC heater, a heat transfer sensor, a heating module, and/or a sensing and heating module.

86. A battery temperature control system according to claim 84, wherein the heating controller is configured to turn the one or more of a self-regulating heater, a PTC heater, a heat transfer sensor, a heating module, and/or a sensing and heating module on or off.

87. A battery temperature control system according to claim 84, wherein the one or more of a self-regulating heater, a PTC heater, a heat transfer sensor, a heating module, and/or a sensing and heating module comprises a PTC material.

88. A battery temperature control system according to claim 87, wherein the PTC material is PTC rubber or a laminate material comprising copper.

89. A battery temperature control system according to claim 88, wherein the laminate material further comprises an insulating material.

90. A battery temperature control system according to claim 84, wherein the one or more of a self-regulating heater, a PTC heater, a heat transfer sensor, a heating module, and/or a sensing and heating module comprises a diode.

91. A battery temperature control system according to claim 90, wherein the diode comprises a diode connected transistor.

92. A battery temperature control system according to claim 84, wherein the one or more of a self-regulating heater, a PTC heater, a heat transfer sensor, a heating module, and/or a sensing and heating module comprises a heating device.

93. A battery temperature control system according to claim 92, wherein the heating device comprises a resistive element.

94. A host device comprising a battery temperature control system according to claim 50.

95. A host device according to claim 94, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.
